(19) United States
(12) Patent Application Publication
(10) Pub. No.: US 2009/0074386 A1
(43) Pub. Date: Mar. 19, 2009

(54) BROADCAST RECEIVER

(75) Inventor: Tomo Hamada, Akishima-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/124,070

(22) Filed: May 20, 2008

(30) Foreign Application Priority Data
Sep. 19, 2007 (JP) 2007242570

(51) Int. Cl. H04N 7/26

(52) U.S. Cl. 386/124; 386/E05.001

(57) ABSTRACT

A recordable/playable rate is measured for a storage device connected to an interface. When a new storage device is connected, whether or not a measurement is previously performed is determined. If the measurement is previously performed, “usable” is determined using the previous measurement result; if the measurement is not yet performed, “usable” or “unusable” is determined in accordance with a result of the measurement for measuring the recordable/playable rate performed by a measurement unit.

### CROSS-REFERENCE TO RELATED APPLICATIONS

This application is based upon and claims the benefit of priority from Japanese Patent Application No. 2007-242570, filed on Sep. 19, 2007, the entire content of which are incorporated herein by reference.

### BACKGROUND

1. Field

One embodiment of the invention relates to a communication apparatus such as a TV set having a network function and in particular to a broadcast receiver and method for recording and reproducing received broadcast content in a digital recording apparatus through a home network, using an USB interface for example.

2. Description of the Related Art

In recent years, digitalization of TV broadcast has been advanced. For example, in Japan, digital terrestrial television broadcasting is also begun in addition to satellite digital broadcasting of BS (Broadcasting Satellite) digital broadcasting, 110-degree CS (Communication Satellite) digital broadcasting.

In a digital broadcast receiver for receiving such digital TV broadcast, for example, a large-capacity digital recorder such as an HDD (Hard Disk Drive) is connected, whereby it is made possible to digitally record a received program and reproducing a recorded program.

Such a digital broadcast receiver stores a function expansion program describing various types of processing to connect an HDD through a USB interface and allow the apparatus to behave as a DTV incorporating a hard disk recorder is stored. Accordingly, HDD of the type connected using a USB cable of a lower price than AV HDD is made to function as a disk subunit on an IEEE 1394 network. An example of such technique is disclosed in JP-A-2007-053692 (counterpart U.S. publication is: US 2007/067550 A1).

However, JP-A-2007-053692 fails to describe that if USB HDD once subjected to measurement of a recordable/playable rate is again connected after it is removed, measurement of a recordable/playable rate is skipped. Thus, the measurement of a recordable/playable rate may be again performed also for USB HDD subjected to measurement of a recordable/playable rate in the past when the USB HDD is again connected after it is removed and that it may take time in the measurement.

### SUMMARY

One of objects of the present invention is to provide a broadcast receiver that performs measurement of a recordable/playable rate USB HDD first connected and when the USB HDD does not reach the recordable/playable performance value, the user is informed of the fact and recording and reproducing of the USB HDD are prohibited.

Another one of objects of the present invention is to provide a broadcast receiver and a method with the measurement time shortened by determining that USB HDD once succeeding in measurement of a recordable/playable rate is usable without again performing measurement of a recordable/playable rate when the USB HDD is again connected after it is removed.

According to a first aspect of the present invention, there is provided a broadcast receiver including: an interface to which a storage device is connected; a measurement unit that measures a recordable/playable rate of the storage device; a storage unit that stores data including information indicating the result of the measurement performed by the measurement unit and identification information for identifying the connected storage device; a connection determination unit that determines, when a new storage device is connected to the interface, whether or not the measurement by the measurement unit is previously performed by determining whether or not identification information that matches with the new storage device is included in the data stored in the storage unit; and a capability determination unit that determines whether or not the new storage device is capable for recording a broadcast program (1) based on the data stored in the storage unit when the connection determination unit determines that the measurement for the new storage device is previously performed and (2) based on the result of the measurement performed by the measurement unit when the connection determination unit determines that the measurement for the new storage device is not yet performed.

According to a second aspect of the present invention, there is provided a broadcast receiver including: an interface to which a storage device is connected; a measurement unit that measures a recordable/playable rate of the storage device; a capability determination unit that determines whether or not the storage device is capable for recording a broadcast program based on the result of the measurement performed by the measurement unit; a storage control unit that control the storage device to store data indicating that the storage device is capable for recording the broadcast program when the capability determination unit determines that the storage device is capable; and a data determination unit that determines, when a new storage device is connected to the interface, whether or not the data indicating that the storage device is capable is stored in the storage device, wherein the capability determination unit determines that the new storage device is capable for recording the broadcast program (1) when the data determination unit determines that the data indicating that the storage device is capable is stored in the storage device and (2) in accordance with the result of the measurement performed by the measurement unit when the data determination unit determines that the data indicating that the storage device is capable is not stored in the storage device.

According to a third aspect of the present invention, there is provided a method for determining capability of a storage device, the method including: measuring a recordable/playable rate of a storage device attached to an interface; storing data including information indicating the result of the measurement and identification information for identifying the connected storage device; determining, when a new storage device is connected to the interface, whether or not the measurement is previously performed for the new storage device by determining whether or not identification information that matches with the new storage device is included in the stored data; and determining whether or not the new storage device is capable for recording a broadcast program (1) based on the stored data when determined that the measurement for the new storage device is previously performed and (2) based on the result of the measurement when determined that the measurement for the new storage device is not yet performed.

According to a fourth aspect of the present invention, there is provided a method for determining capability of a storage device, the method including: measuring a recordable/playable rate of a storage device attached to an interface; determining whether or not the storage device is capable for recording a broadcast program based on the result of the measurement; controlling the storage device to store data indicating that the storage device is capable for recording the broadcast program when determined that the storage device is capable; determining, when a new storage device is connected to the interface, whether or not the data indicating that the storage device is capable is stored in the storage device; and determining that the new storage device is capable for recording the broadcast program (1) when determined that the data indicating that the storage device is capable is stored in the storage device and (2) in accordance with the result of the measurement when determined that the data indicating that the storage device is capable is not stored in the storage device.

### BRIEF DESCRIPTION OF THE SEVERAL VIEWS OF THE DRAWINGS

A general configuration that implements the various feature of the invention will now be described with reference to the drawings. The drawings and the associated descriptions are provided to illustrate embodiments of the invention and not to limit the scope of the invention.

FIG. 1 is a drawing to describe the appearance of a digital TV broadcast receiver according to an embodiment of the present invention and a network system configured to be included with the digital TV broadcast receiver.

FIG. 2 is a block diagram to show a main signal processing system of the digital TV broadcast receiver.

FIG. 3 is a flowchart to describe an operation according to a first embodiment.

FIG. 4 is a drawing to show an example of a GUI screen.

FIG. 5 is a drawing to show an example of a message screen indicating that USB HDD is previously subjected to a measurement test of the recordable/playable rate.

FIG. 6 is a drawing to show an example of a message screen indicating that registration of newly connected USB HDD is canceled.

FIG. 7 is a drawing to show an example of a message screen indicating that the USB HDD cannot be used for recording/reproduction.

FIG. 8 is a flowchart to describe an operation according to a second embodiment.

FIG. 9 is a flowchart to show an example of measurement processing of a follow-up reproduction rate by the digital TV broadcast receiver 111 according to the embodiment.

FIGS. 10A and 10B are drawings to show examples of a measurement list of recordable/playable rates.

FIG. 11 is a drawing to show an example of a disk ID file (did.bin).

### DETAILED DESCRIPTION

Referring now to the accompanying drawings, there are shown embodiments of the present invention.

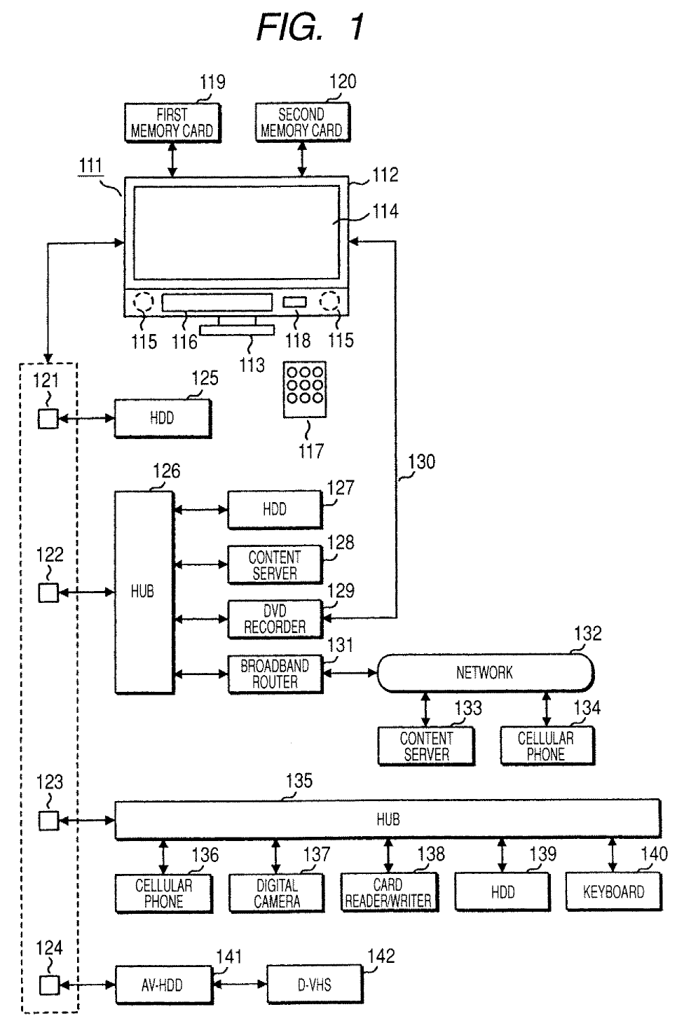

FIG. 1 schematically shows the appearance of a digital TV broadcast receiver 111, which is shown as a first embodiment of the present invention, including a network function and an example of a network system configured to be provided with the digital TV broadcast receiver 111.

The digital TV broadcast receiver 111 includes a flat cabinet 112 and a support bed 113 for supporting the cabinet 112 in an upright position. Installed in the cabinet 112 are a flat-panel video display 114 including display devices such as an SED (Surface-conduction Electron-emitter Display) display panel and a liquid crystal display panel, speakers 115, an operation section 116, a light reception section 118 for receiving operation information transmitted from a remote control 117.

A first memory card 119, which may be a memory card such as an SD (Secure Digital) memory card, an MMC (Multimedia Card), and a memory stick, can be attached to and detached from the digital TV broadcast receiver 111, and is used to record and reproduce information such as a program and a photo image.

A second memory card (IC card) 120, on which contract information is recorded, can be attached to and detached from the digital TV broadcast receiver 111, and is used to record and reproduce information.

The digital TV broadcast receiver 111 also includes a first LAN (Local Area Network) terminal 121, a second LAN terminal 122, a USB (Universal Serial Bus) terminal 123, and an i.LINK terminal 124.

The first LAN terminal 121 is used as a port dedicated to a LAN-compatible HDD and is used to record and reproduce information through Ethernet (registered trademark) with a LAN-compatible HDD 125 of connected NAS (Network Attached Storage).

The first LAN terminal 121 as a port dedicated to a LAN-compatible HDD is thus provided, whereby information recording of a program with high-definition image quality can be stably performed with the LAN-compatible HDD 125 without being affected by any other network environment and the network use situation.

The second LAN terminal 122 is used as a general LAN-compatible port using Ethernet (registered trademark); it is used to connect apparatuses of a LAN-compatible HDD 127, a content server 128, a DVD (Digital Versatile Disk) recorder 129 containing an HDD, through a hub 126, for example, for transferring information to and from the apparatuses.

The content server 128 is implemented as a UPnP (universal plug and play) compatible apparatus having a function to operate as a server apparatus of content in a home network and further including service for providing URI (Uniform Resource Identifier) information required for accessing content.

It is preferable for the DVD recorder 129 to be provided with a dedicated analog transmission line 130 to transfer analog video and audio information to and from the digital TV broadcast receiver 111 because digital information communicated through the second LAN terminal 122 is information of a control system only.

The second LAN terminal 122 is used to connect to a network 132, such as the Internet, through a broadband router 131 connected to the hub 126 for transferring information to and from a target such as a content server 133 or a cellular phone 134.

The content server 133 is implemented as a UPnP-compatible apparatus having a function to operate as a server apparatus of content and further including service for providing URI information required for accessing content.

The USB terminal 123 is used as a general USB-compatible port. The USB terminal 123 is used to connect USB apparatuses of a cellular phone 136, a digital camera 137, a card reader/writer 138 for a memory card, an HDD 139, a keyboard 140, etc., through a hub 135, for example, for transferring information to and from the USB apparatuses.

The i.LINK terminal 124 is used to connect an AV-HDD 141, a D (Digital)-VHS (Video Home System) 142, etc., for example, in series for transferring information to and from the apparatuses.

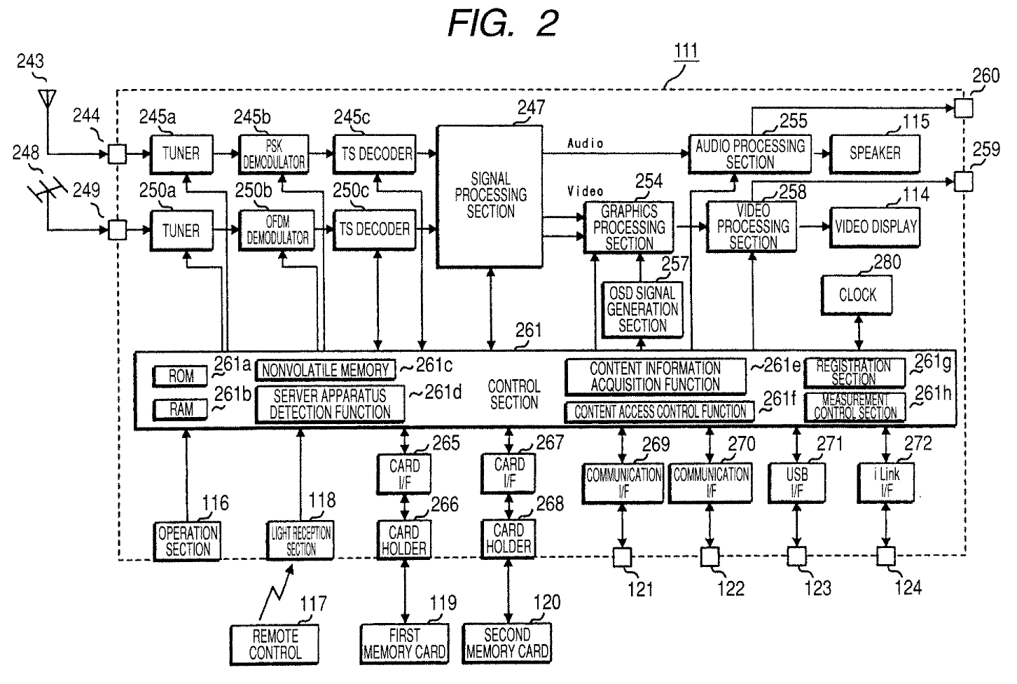

FIG. 2 shows the main signal processing system of the digital TV broadcast receiver 111.

That is, a satellite digital TV broadcast signal received at an antenna 243 for BS/CS digital broadcast reception is supplied to a tuner 245a for satellite digital broadcast through an input terminal 244.

The tuner 245a selects a broadcast signal of any desired channel according to a control signal from a control section 261 and outputs the selected broadcast signal to a PSK (Phase Shift Keying) demodulator 245b.

The PSK demodulator 245b demodulates the broadcast signal selected by the tuner 245a according to a control signal from the control section 261, obtains a transport stream containing the desired program, and outputs the transport stream to a TS decoder 245c.

The TS decoder 245c performs TS decoding processing of the transport stream (TS)-multiplexed signal according to a control signal from the control section 261 and depackets the digital video signal and audio signal of the desired program to provide a PES (Packetized Elementary Stream) and then outputs the PES to an STD buffer 247f in a signal processing section 247.

The TS decoder 245c outputs section information sent over digital broadcast to a section processing section 247h in the signal processing section 247.

A digital terrestrial television broadcasting signal received at an antenna 248 for terrestrial broadcast reception is supplied to a tuner 250a for digital terrestrial broadcast through an input terminal 249.

The tuner 250a selects a broadcast signal of any desired channel according to a control signal from the control section 261 and outputs the selected broadcast signal to an OFDM (Orthogonal Frequency Division Multiplexing) demodulator 250b.

The OFDM demodulator 250b demodulates the broadcast signal selected by the tuner 250a according to a control signal from the control section 261, obtains a transport stream containing the desired program, and outputs the transport stream to a TS decoder 250c.

The TS decoder 250c performs TS decoding processing of the transport stream (TS)-multiplexed signal according to a control signal from the control section 261 and depackets the digital video signal and audio signal of the desired program to provide a PES (Packetized Elementary Stream) and then outputs the PES to the STD buffer 247f in the signal processing section 247.

The TS decoder 250c outputs section information sent over digital broadcast to the section processing section 247h.

At the TV viewing time, the signal processing section 247 selectively performs predetermined digital signal processing for the digital video signals and audio signals supplied from the TS decoder 245c and the TS decoder 250c and outputs the signals to a graphics processing section 254 and an audio processing section 255. At the content reproduction time, the signal processing section 247 selects a content reproduction signal input from the control section 261, performs predetermined digital signal processing, and outputs the signal to the graphics processing section 254 and the audio processing section 255.

From the signal processing section 247, various pieces of data, electronic program guide (EPG) information, program attribute information (program genre, etc.,), caption information, etc., (service information, SI, and PSI), and the like to acquire a program are input to the control section 261.

The control section 261 performs image generation processing to display EPG and caption from the input information and outputs the generated image information to the graphics processing section 254.

The section processing section 247h outputs various pieces of data, electronic program guide (EPG) information, program attribute information (program genre, etc.,), caption information, etc., (service information, SI, and PSI), and the like to acquire a program to the control section 261 from the section information input from the TS decoder 245c (250c) to the control section 261.

The graphics processing section 254 has a function of combining (1) a digital video signal supplied from an AV decoder 247g in the signal processing section 247, (2) an OSD (On Screen Display) signal generated in an OSD signal generation section 257, (3) image data of data broadcasting, and (4) EPG, caption signal, and GUI screen generated by the control section 261 and outputs the composite signal to a video processing signal 258.

To display a caption of broadcast captioning, the graphics processing section 254 performs processing of superposing caption information on a video signal based on the caption information under the control of the control section 261.

The digital video signal output from the graphics processing section 254 is supplied to the video processing signal 258. The video processing signal 258 converts the input digital video signal into an analog video signal in a format that can be displayed on the video display 114 and then outputs the analog video signal to the video display 114 for displaying the video and also outputs the analog video signal through an output terminal 259 to external devices.

The audio processing section 255 converts the input digital audio signal into an analog audio signal in a format that can be played back with the speakers 115 and then outputs the analog audio signal to the speakers 115 for reproducing the audio and also outputs the analog audio signal through an output terminal 260 to the outside.

All operation including the reception operation described above of the digital TV broadcast receiver 111 is totally controlled by the control section 261. The control section 261, which contains a CPU (Central Processing Unit), etc., receives operation information from the operation section 116 or receives operation information sent from the remote control 117 through the light reception section 118 and controls the sections so that the operation descriptions are reflected.

In this case, the control section 261 mainly uses ROM (Read-Only Memory) 261a storing a control program performed by the CPU, RAM (Random Access Memory) 261b for providing a work area for the CPU, and nonvolatile memory 261c for storing various pieces of set information, control information, etc.

The control section 261 is connected through a card I/F (Interface) 265 to a cardholder 266 in which the first memory card 119 can be placed. Accordingly, the control section 261 can transfer information through the card I/F 265 to and from the first memory card 119 placed in the card holder 266.

Further, the control section 261 is connected through a card I/F 267 to a card holder 268 in which the second memory card 120 can be placed. Accordingly, the control section 261 can transfer information through the card I/F 267 to and from the second memory card 120 placed in the card holder 268.

The control section 261 is also connected through a communication I/F 269 to the first LAN terminal 121. Accordingly, the control section 261 can transfer information through the communication I/F 269 to and from the LAN-compatible HDD 125 connected to the first LAN terminal 121. In this case, the control section 261 has a DHCP (Dynamic Host Configuration Protocol) server function and assigns an IP (Internet Protocol) address to the LAN-compatible HDD 125 connected to the first LAN terminal 121 for control.

Further, the control section 261 is connected through a communication I/F 270 to the second LAN terminal 122. Accordingly, the control section 261 can transfer information through the communication I/F 270 to and from the apparatuses connected to the second LAN terminal 122 (see FIG. 1).

The control section 261 is also connected through a USB I/F 271 to the USB terminal 123. Accordingly, the control section 261 can transfer information through the USB I/F 271 to and from the apparatuses connected to the USB terminal 123 (see FIG. 1).

The control section 261 is connected through an i.LINK I/F 272 to the i.LINK terminal 124. Accordingly, the control section 261 can transfer information through the i.LINK I/F 272 to and from the apparatuses connected to the i.LINK no terminal 124 (see FIG. 1).

In the embodiment, a registration file describing storage IDs (each containing IP address and apparatus name) assigned to the HDD 125, the HDD 127, the content server 128, and the DVD recorder 129 at the initial registration time is stored in the LAN-compatible HDD 125.

The storage IDs of the LAN-compatible HDDs 125 and 127, the content server 128, and the DVD recorder 129 are stored in the nonvolatile memory 261c.

The control section 261 includes (1) a server apparatus detection function 261d using UPnP, (2) a content information acquisition function 261e using UPnP, and (3) a content access control function 261f.

(1) The control section 261 detects a UPnP-compatible apparatus on the network using a UPnP detection function by the server apparatus detection function 261d. For example, the server apparatus detection function 261d detects the content server 128 using the UPnP detection function.

(2) The control section 261 controls a UPnP-compatible apparatus using a UPnP control function and acquires URI information required for accessing content in the UPnP-compatible apparatus by the content information acquisition function 261e. For example, the content information acquisition function 261e controls the content server 128 and acquires the URI information required for accessing content stored in the HDD in the content server 128 from the content server 128.

(3) The control section 261 determines whether or not access to the content is to be permitted based on the IP address information of the server apparatus acquired by the server apparatus detection function 261d, the IP address information obtained from the URI information acquired by the content information acquisition function 261e, and the IP address and net mask assigned to the LAN terminal 122 of the digital TV broadcast receiver 111 by the content access control function 261f. If the control section 261 determines that the content access is to be permitted, it permits the content access; if the control section 261 does not determine that the content access is to be permitted, it displays a message to the effect that the content access is not permitted as OSD on the video display 114.

The control section 261 has a registration section 261g for registering a recording and reproduction apparatus for performing recording and reproduction processing on the network and a measurement control section 261h for measuring the recording rate for recording a file at any desired recording/reproduction position, and performs measurement processing described later in detail.

The case where the HDD 139 of a USB apparatus is connected using the USB terminal 123 of a general USB-compatible port and recording/reproduction is performed in the HDD 139 (which will be hereinafter referred to as USB HDD 139) will be discussed below:

However, the broadcast receiver according to the present invention is not limited to be provided with the USB but may be provided with any other interface such as IEEE 1394 or LAN-HDD.

As shown in FIG. 1, the USB HDD 139 is used with a plurality of USB apparatuses through the hub 135; however, preferably a dedicated port is provided, whereby reception of the effect of any other apparatus can be prevented.

Next, the operation of the first embodiment will be discussed in detail with FIG. 3 for a case when measurement information of recordable/playable rate is stored in digital TV broadcast receiver 111.

FIG. 3 is a flowchart to describe the operation of the first embodiment of the invention. Unless otherwise noted, the following operation is performed under the control of the control section 261.

The digital TV broadcast receiver 111 stores a measurement list of recordable/playable rates in a predetermined area of the nonvolatile memory 261c. At least the serial number data, the vendor name data, and the measurement result are combined in a set in the data of the measurement list of recordable/playable rates.

The data stored as the measurement result may be the measurement rate as shown in FIG. 10A or may be information indicating usable or unusable as shown in FIG. 10B. When measurement rate is adopted as the data stored as the measurement result, usable/unusable (capable/uncapable) can be determined from the read measurement rate.

When a USB HDD 139 not yet connected to the digital TV broadcast receiver 111 having a recording and reproduction function is first connected to the digital TV broadcast receiver 111, the digital TV broadcast receiver 111 detects the apparatus by a method of hot plug, polling, etc., (step S301).

The digital TV broadcast receiver 111 verifies the detected USB HDD serial number and vendor name of the USB HDD 139 detected at step S301 with the serial number and the vendor name described in the measurement list of recordable/playable rates stored in the nonvolatile memory 261c (step S302).

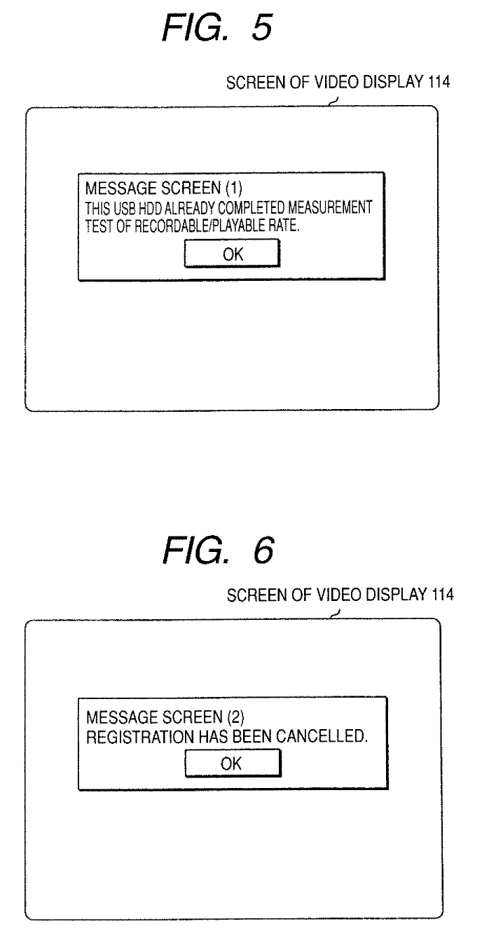

When the detected USB HDD serial number and vendor name of the USB HDD 139 detected at step S301 exist in the measurement list of recordable/playable rates (YES at step S302), it is determined that the connected USB HDD 139 is the USB HDD 139 whose recordable/playable rate has already been measured, and a message screen indicating that the USB HDD already passes a measurement test of the recordable/playable rate is displayed as shown in FIG. 5.

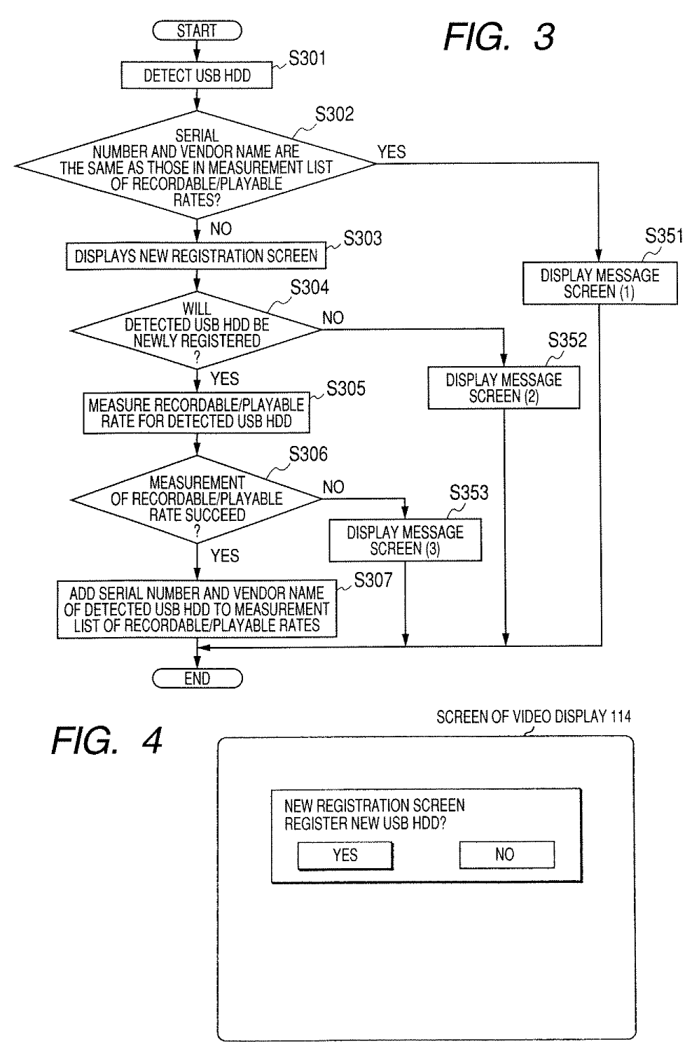

When the detected USB HDD serial number and vendor name of the USB HDD 139 detected at step S301 do not exist in the measurement list of recordable/playable rates (NO at step S302), it is determined that the connected USB HDD 139 is not yet registered (is a newly connected USB HDD) and a GUI as shown in FIG. 4 to ascertain whether or not the user will newly register the USB HDD is displayed (step S303). The GUI screen may be generated by the control section 261 and the graphics processing section 154 and may be superposed on the screen.

When the user selects YES and presses a determination button of the remote control 117, for example, in response to the GUI screen shown in FIG. 4 (YES at step S304), a recordable/playable rate is measured for the detected USB HDD 139 (step S305). On the other hand, if the user selects NO and presses the determination button of the remote control 117, for example, (NO at step S304), a message screen (2) indicating that registration of the newly connected USB HDD 139 has been canceled is displayed as shown in FIG. 6.

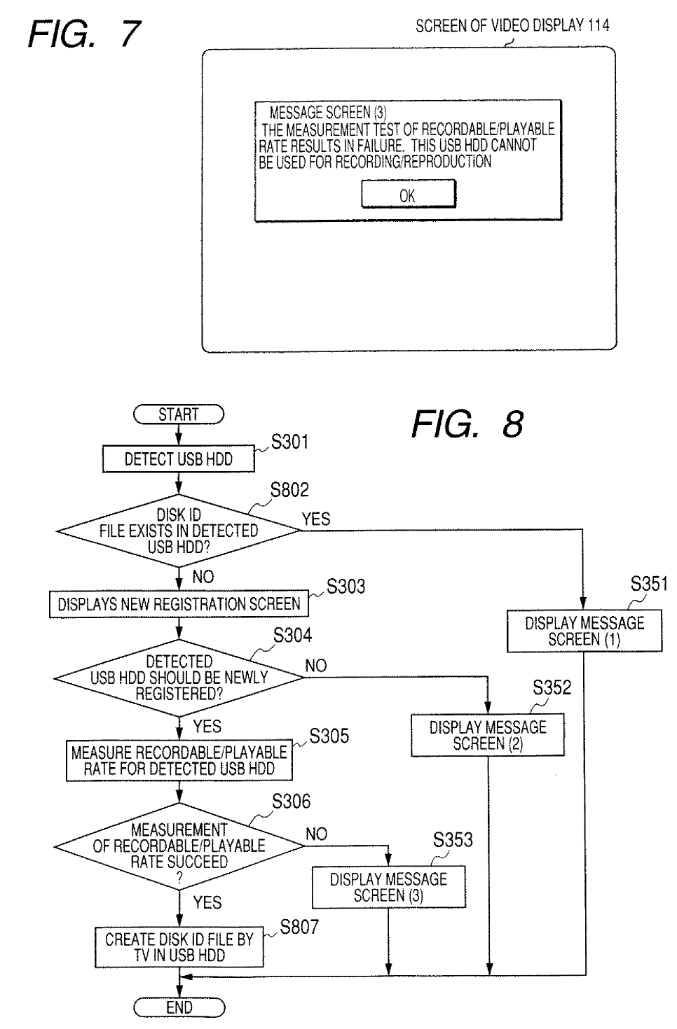

When the measurement of the recordable/playable rate at step S305 results in success (YES at step S306), the serial number and the vendor name of the USB HDD 139 detected are added to the measurement list of recordable/playable rates and the measurement list of recordable/playable rates stored in the nonvolatile memory 261c is updated. When the measurement of the recordable/playable rate results in failure (NO at step S306), the user is informed that the USB HDD cannot be used for recording/reproduction by displaying a message screen (3) shown in FIG. 7.

As described above with reference to the first embodiment, there is provided a broadcast receiver and method with the measurement time shortened by skipping measurement of a recordable/playable rate if the USB HDD once subjected to measurement of a recordable/playable rate is again connected after it is removed.

Next, a second embodiment according to the invention will be described in detail with FIG. 8.

The second embodiment is provided by modifying a part of the first embodiment; only the portions different from the first embodiment will be discussed and the same portions will not be discussed again.

Next, an operation of the second embodiment will be discussed in detail with FIG. 8 for a case when measurement information of recordable/playable rate is stored in USB HDD.

Unless otherwise noted, the following operation is performed under the control of a control section 261.

In the first embodiment described above, a measurement list of recordable/playable rates is stored in the predetermined area of the nonvolatile memory 261c of the digital TV broadcast receiver 111 and is used to determine whether or not the USB HDD is newly connected.

In contrast, the second embodiment differs from the first embodiment in that whether or not USB HDD is newly connected is determined according to whether or not a disk ID file exists in the USB HDD.

FIG. 8 is a flowchart to describe the operation of the second embodiment of the invention, which differs from FIG. 3 in that steps S802 and S807 are added in place of steps S302 and S307.

When a USE HDD 139 not yet connected to the digital TV broadcast receiver 111 having a recording and reproduction function is first connected to the digital TV broadcast receiver 111, the digital TV broadcast receiver 111 detects the apparatus by a method of hot plug, polling, etc., (step S301).

The control section 261 of the digital TV broadcast receiver 111 checks whether or not a disk ID file exists in the USE HDD detected at step S301 (step S802). The disk ID file is a file in which the unique ID assigned from the digital TV broadcast receiver 111 is described.

When a disk ID file exists in the USE HDD detected at step S301 (YES at step S802), it is determined that the connected USB HDD 139 is the USE HDD 139 whose recordable/playable rate has already been measured.

When no disk ID file exists in the USB HDD detected at step S301 (NO at step S802), it is determined that the connected USE HDD 139 is not yet registered (is a newly connected USB HDD) and a GUI as shown in FIG. 4 to ascertain whether or not the user will newly register the USB HDD is displayed (step S303). The GUI screen may be generated by the control section 261 and a graphics processing section 154 and may be superposed on the screen.

When the user selects YES and presses a determination button of the remote control 117, for example, in response to the GUI screen shown in FIG. 4 (YES at step S304), a recordable/playable rate is measured for the detected USB HDD 139 (step S305). On the other hand, if the user selects NO and presses the determination button of the remote control 117, for example, (NO at step S304), a message screen (2) shown in FIG. 6 is displayed.

When the measurement of the recordable/playable rate at step S305 results in success (YES at step S306), a disk ID file is created in the USB HDD 139 (step S807). In contrast, if the measurement of the recordable/playable rate results in failure (NO at step S306), the user is informed that the USB HDD cannot be used for recording/reproduction by displaying a message screen (3) shown in FIG. 7.

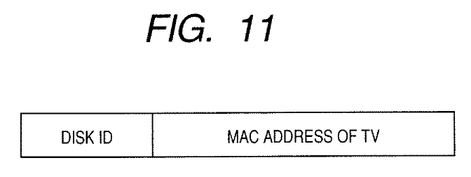

FIG. 11 is a drawing to show an example of the disk ID file in the USB HDD 139. The disk ID file includes the disk ID generated by the control section 261 of the digital TV broadcast receiver 111 and MAC address of the digital TV broadcast receiver 111. The whole disk ID file is encrypted with a cipher key of the digital TV broadcast receiver 111.

The disk ID file is thus encrypted, so that tampering of the disk ID file by the user can be prevented.

As described above with reference to the second embodiment, there is provided a broadcast receiver and method with the measurement time shortened by skipping measurement of a recordable/playable rate if the USB HDD once subjected to measurement of a recordable/playable rate is again connected after it is removed.

Next, an example of measuring a recordable/playable rate in the first and second embodiments described above will be discussed.

In the following description, measurement processing of a follow-up reproduction rate is taken as an example; however, when the function of follow-up reproduction (performing reproduction while performing recording of the program) is not used, simply the recording rate and the reproduction rate may be measured and whether or not the USB HDD can be used for recording/reproduction may be determined according to whether or not a predetermined value is satisfied.

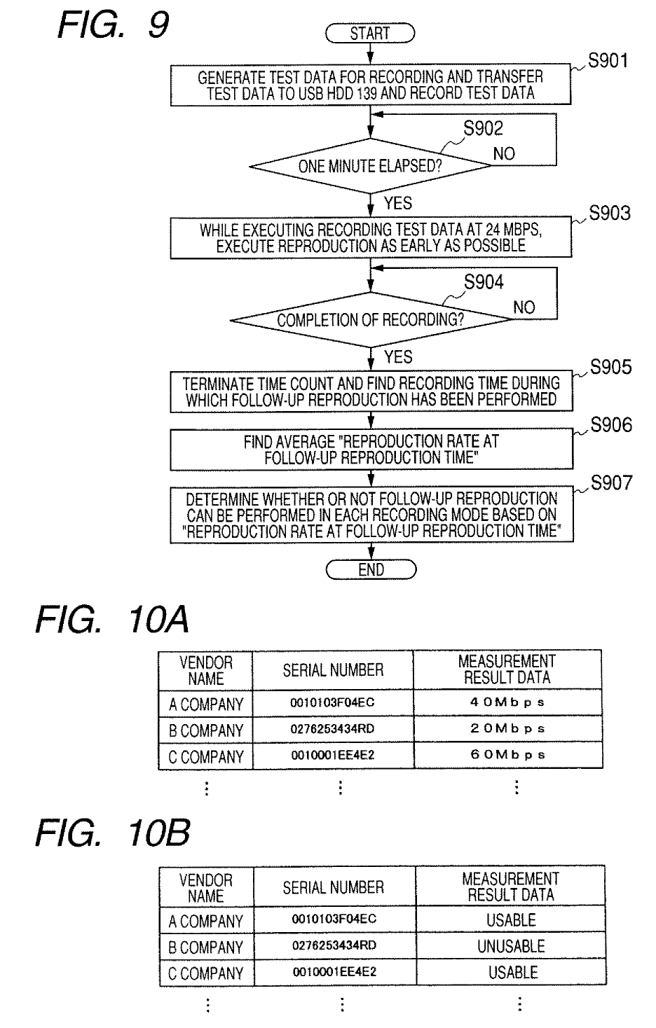

Next, measurement processing of a follow-up reproduction rate by the digital TV broadcast receiver 111, a communication apparatus having the configuration will be discussed below in detail with FIG. 9:

FIG. 9 is a flowchart to show an example of the measurement processing of the follow-up reproduction rate of the USB HDD 139 by the digital TV broadcast receiver 111.

Step S901: When measurement starts, any 24-Mbps test data for recording contained in the measurement control section 261h is generated by the action of a program, etc., contained in the measurement control section 261h and is transferred to the USB HDD 139 and recording is started and time count is also started. At step S901, 24-Mbps test data is adopted and the data is written for executing follow-up reproduction at later steps and thus the data is not limited to it; however, since the 24-Mbps test data is generated, it is also assumed here that the data is written at 24 Mbps.

Step S902: Whether or not time of one minute, for example, has elapsed since recording the test data in the USB HDD 139 was started is determined and if the time of one minute has elapsed, the process goes to step S903.

Step S903: While recording the test data in the USB HDD 139 at 24 Mbps (rate as much as one channel of satellite high-definition broadcast) is performed, reproduction is performed as early as possible while the recording is given a higher priority from the record start point of the recorded data, and the played-back data is transmitted to the digital TV broadcast receiver 111. At this time, reproduction is performed within the range in which the record is not broken by controlling in a record priority mode described later. To execute reproduction as early as possible, a data request is made immediately when the data is received from the USB HDD 139.

Step S904: Whether or not the recording is complete is determined and if the recording is complete, the process goes to step S905.

Step S905: The time count is terminated and the recording time during which the follow-up reproduction has been performed is found. The time during which the follow-up reproduction has been performed can be found from (time period from time count start to completion of recording)—one minute. Average “recording rate at follow-up reproduction time” is found, for example, according to (size of recorded test data)/(recording time during which follow-up reproduction has been performed) by the action of the measurement control section 261h.

Step S906: Average “reproduction rate at follow-up reproduction time” is found, for example, according to (size of played-back test data)/(recording time during which follow-up reproduction has been performed) by the action of the measurement control section 261h by the action of the measurement control section 261h. The “recording rate at follow-up reproduction time” and the “reproduction rate at follow-up reproduction time” are found as the rate at which follow-up reproduction of video and audio signals can be performed in the USB HDD 139. Here, the “recording rate at follow-up reproduction time” or the “reproduction rate at follow-up reproduction time,” whichever is lower, is adopted as the final “follow-up playable rate.” That is, to reproduce the video and audio signals in a high image quality mode, since the capacity is too large, the total transfer capability of the network and the communication apparatus may be insufficient and reproduction may become impossible. Thus, only a follow-up reproduction mode performed in the allowable range of the transfer rate is the follow-up reproduction mode that can be handled in the USB HDD 139. If the “recording rate at follow-up reproduction time” is 24 Mbps and the “reproduction rate at follow-up reproduction time” is 24 Mbps as the measurement result of the USB HDD 139, the “follow-up playable rate” becomes 24 Mbps.

Step S307: Whether or not follow-up reproduction can be performed in each recording mode is determined based on the “reproduction rate at follow-up reproduction time.”

It is to be understood that the present invention is not limited to the specific embodiments described above and that the invention can be embodied with the components modified without departing from the spirit and scope of the invention. The invention can be embodied in various forms according to appropriate combinations of the components disclosed in the embodiments described above. For example, some components may be deleted from all components shown in the embodiment. Further, the components in different embodiments may be used appropriately in combination. For example, the first and second embodiments may be combined and a genre and a channel may be paired as any desired program attribute.

What is claimed is:

1. A broadcast receiver comprising:
an interface to which a storage device is connected;
a measurement unit that measures a recordable/playable rate of the storage device;
a storage unit that stores data including information indicating the result of the measurement performed by the measurement unit and identification information for identifying the connected storage device;
a connection determination unit that determines, when a new storage device is connected to the interface, whether or not the measurement by the measurement unit is previously performed by determining whether or not identification information that matches with the new storage device is included in the data stored in the storage unit; and
a capability determination unit that determines whether or not the new storage device is capable for recording a broadcast program (1) based on the data stored in the storage unit when the connection determination unit determines that the measurement for the new storage device is previously performed and (2) based on the result of the measurement performed by the measurement unit when the connection determination unit determines that the measurement for the new storage device is not yet performed.

2. The broadcast receiver according to claim 1, wherein the storage unit stores information indicating a serial number and a vendor name of the storage device in association with the information indicating the result of the measurement.

3. The broadcast receiver according to claim 1, wherein the storage unit stores information indicating at least one of (1) the recordable/playable rate and (2) a flag indicating capability for recording the broadcast program, as the information the result of the measurement.

4. A broadcast receiver comprising:
an interface to which a storage device is connected;
a measurement unit that measures a recordable/playable rate of the storage device;
a capability determination unit that determines whether or not the storage device is capable for recording a broadcast program based on the result of the measurement performed by the measurement unit;
a storage control unit that control the storage device to store data indicating that the storage device is capable for recording the broadcast program when the capability determination unit determines that the storage device is capable; and
a data determination unit that determines, when a new storage device is connected to the interface, whether or not the data indicating that the storage device is capable is stored in the storage device,
wherein the capability determination unit determines that the new storage device is capable for recording the broadcast program (1) when the data determination unit determines that the data indicating that the storage device is capable is stored in the storage device and (2) in accordance with the result of the measurement performed by the measurement unit when the data determination unit determines that the data indicating that the storage device is capable is not stored in the storage device.

5. A method for determining capability of a storage device, the method comprising:
measuring a recordable/playable rate of a storage device attached to an interface;
storing data including information indicating the result of the measurement and identification information for identifying the connected storage device;
determining, when a new storage device is connected to the interface, whether or not the measurement is previously performed for the new storage device by determining whether or not identification information that matches with the new storage device is included in the stored data; and
determining whether or not the new storage device is capable for recording a broadcast program (1) based on the stored data when determined that the measurement for the new storage device is previously performed and (2) based on the result of the measurement when determined that the measurement for the new storage device is not yet performed.

6. A method for determining capability of a storage device, the method comprising:
measuring a recordable/playable rate of a storage device attached to an interface;
determining whether or not the storage device is capable for recording a broadcast program based on the result of the measurement;
controlling the storage device to store data indicating that the storage device is capable for recording the broadcast program when determined that the storage device is capable;
determining, when a new storage device is connected to the interface, whether or not the data indicating that the storage device is capable is stored in the storage device; and
determining that the new storage device is capable for recording the broadcast program (1) when determined that the data indicating that the storage device is capable is stored in the storage device and (2) in accordance with the result of the measurement when determined that the data indicating that the storage device is capable is not stored in the storage device.
